(19) United States
(12) Patent Application Publication
(10) Pub. No.: US 2024/0170764 A1
(43) Pub. Date: May 23, 2024

(54) ENERGY STORAGE DEVICE COMPRISING AN INTEGRATED INTAKE/EXHAUST DUCT

(71) Applicants: HYUNDAI MOTOR COMPANY, Seoul (KR); KIA CORPORATION, Seoul (KR); Duck Yang Industry Co., Ltd., Ulsan (KR)

(72) Inventors: Sun Jun Kim, Yongin-si (KR); Hyung Seok Choi, Seoul (KR); Hee Jun Do, Suwon-si (KR); In Mook Park, Suwon-si (KR); Jae Yong Lee, Suwon-si (KR); Ki Won Jung, Suwon-si (KR)

(73) Assignees: HYUNDAI MOTOR COMPANY, Seoul (KR); KIA CORPORATION, Seoul (KR); Duck Yang Industry Co., Ltd., Ulsan (KR)

(21) Appl. No.: 18/512,550

(22) Filed: Nov. 17, 2023

(30) Foreign Application Priority Data
Nov. 18, 2022 (KR) 10-2022-0155668

(51) Int. Cl. H01M 10/6563; H01M 10/652; H01M 10/6556

(52) U.S. Cl. CPC H01M 10/6563; H01M 10/652; H01M 10/6556

(57) ABSTRACT

An energy storage device is equipped with an intake and exhaust integrated duct. The intake and exhaust integrated duct is capable of achieving a uniform cooling effect in a plurality of battery modules by distributing air to each cell module of a battery.

### CROSS-REFERENCE TO RELATED APPLICATION

The present application claims priority to Korean Patent Application No. 10-2022-0155668, filed on Nov. 18, 2022, the entire contents of which are incorporated herein by reference.

### BACKGROUND

### (a) Technical Field

The present disclosure relates to an air-cooled energy storage device.

### (b) Description of the Related Art

In general, internal combustion engine vehicles use gasoline or heavy oil as a main fuel and are a major contributor to air pollution. Therefore, in recent years, electric vehicles or hybrid vehicles have been actively developed to reduce pollution, and thus have been designed to utilize batteries as a power source. Recently, a high-power secondary battery using a non-aqueous electrolyte solution having a high energy density has been developed. Additionally, a large-capacity battery pack configured by connecting a plurality of high-power secondary batteries in series has been achieved. The large-capacity battery pack is generally used in devices requiring a large amount of power, such as driving a motor of an electric vehicle.

As described above, a large-capacity battery pack typically includes a plurality of secondary batteries connected in series. An appropriate cooling system is used to cool the battery pack due to the high heat generated during the charging and discharging of the battery, which can adversely impact the performance and life of the battery. Furthermore, battery packs used in hybrid vehicles are mainly installed in the trunk space, and an air-cooled cooling device with a simple cooling structure is used.

Conventional secondary batteries face challenges in terms of cooling, particularly when utilizing a single module battery pack being composed of two or more single modules to improve the performance of the vehicle. This arrangement often results in low cooling efficiency. FIG. 12 illustrates an arrangement structure of a battery pack according to the related art. In this configuration, when air is introduced from a side of the first battery 10, the air initially cools the first battery 10, leading to a first cooling cycle (as indicated by a first row of arrows). However, as the air moves to the second battery 20, it becomes further heated during the second cooling cycle (as indicated by a second row of arrows). Subsequently, when the air moves to the third battery 30 (as indicated by a third row of arrows), the air is further heated, thereby hindering the effective cooling of the third battery 30.

The above-described background technology is only to enhance understanding of the background of the present disclosure. Therefore, the above-described background technology should not be accepted as recognizing that it corresponds to the prior art already known to those having ordinary skill in the art.

### SUMMARY

Various aspects of the present disclosure are directed to providing an energy storage device equipped with an intake and exhaust integrated duct. The intake and exhaust integrated duct is capable of achieving a uniform cooling effect in a plurality of battery packs by distributing air to a cell module or a capacitor module of a battery.

An energy storage device, according to at least one embodiment of the present disclosure, includes a plurality of cell modules, and at least one intake and exhaust duct (hereinafter “intake/exhaust duct”) that is mounted or arranged between two cell modules among the plurality of cell modules. In one form, multiple intake/exhaust ducts are respectively arranged between adjacent cells of the plurality of cell modules. Each of the intake/exhaust ducts includes a first supply flow passage to supply air to one of the plurality of cell modules and a first discharge flow passage to discharge air discharged from one of the plurality of cell modules. The energy storage device also includes an inlet duct having a first inlet and at least one first outlet each of which is connected to the first supply flow passage of each of the at least one intake/exhaust ducts. The energy storage device also includes an outlet duct having a second outlet and at least one second inlet each of which is connected to the first discharge flow passage of each of the at least one intake/exhaust ducts.

In at least one embodiment of the present disclosure, each of the intake/exhaust ducts includes a first connection unit connecting to one of the at least one first outlet, and a second connection unit connecting to one of the at least one second inlet. Further, each of the intake/exhaust ducts includes a third connection unit extending from the first connection unit toward the second connection unit and having an opening connecting to one side of a cell module of the plurality of cell modules. Furthermore, each of the intake/exhaust ducts includes a fourth connection unit extending from the second connection unit toward the first connection unit and having an opening connecting to one side of another cell module of the plurality of cell modules.

In at least one embodiment of the present disclosure, the inlet duct and the outlet duct are disposed at both lateral sides of the plurality of cell modules.

In at least one embodiment of the present disclosure, the inlet duct is disposed above the plurality of cell modules and the outlet duct is disposed at a lateral side of the plurality of cell modules.

In at least one embodiment of the present disclosure, the inlet duct is disposed above the plurality of cell modules and the outlet duct is disposed below the plurality of cell modules.

In at least one embodiment of the present disclosure, each of the intake/exhaust ducts includes a partition wall separating the first supply flow passage and the first discharge flow passage from each other. The partition wall extends in a diagonal direction between the first connection unit and the second connection unit.

In at least one embodiment of the present disclosure, the partition wall further includes at least one guide plate configured to guide a flow of the air toward the one of the plurality of cell modules.

In at least one embodiment of the present disclosure, the one of the at least one first outlet is inserted into the first connection unit of the at least one intake/exhaust duct. A first sealing member is mounted on an outer surface of the one of the at least one first outlet.

In at least one embodiment of the present disclosure, the one of the at least one second inlet is inserted into the second connection unit of the at least one intake/exhaust duct. A second sealing member is mounted on an outer surface of the one of the at least one second inlet.

In at least one embodiment of the present disclosure, the energy storage device further includes an intake duct connected to one of the at least one first outlet and having a second supply flow passage for supplying air to one of the plurality of cell modules. The energy storage device further includes an exhaust duct connected to one of the at least one second inlet and having a second discharge flow passage for discharging air discharged from one of the plurality of cell modules.

In at least one embodiment of the present disclosure, the inlet duct further includes a first extension unit connected to the exhaust duct. The outlet duct further includes a second extension unit connected to the intake duct.

In at least one embodiment of the present disclosure, the inlet duct and the outlet duct further include fastening units.

In at least one embodiment of the present disclosure, the energy storage device further includes a blower located at the first inlet or the second outlet, and configured to discharge air introduced from the first inlet to the second outlet.

In at least one embodiment of the present disclosure, each of the intake/exhaust ducts includes a partition wall configured to separate the first supply flow passage and the first discharge flow passage from each other. The partition wall includes a plurality of horizontal walls extending in a longitudinal direction and a plurality of vertical walls extending in a perpendicular direction from ends of the plurality of horizontal walls.

In at least one embodiment of the present disclosure, the inlet duct is formed to have a cross-section that becomes narrower at a downstream portion.

In at least one embodiment of the present disclosure, the outlet duct is formed to have a cross-section which becomes wider at a downstream portion.

In at least one embodiment of the present disclosure, the first connection unit and the second connection unit have cross-sections wider than that of an intermediate portion formed between the first connection unit and the second connection unit.

In at least one embodiment of the present disclosure, the first inlet is formed at an end of the inlet duct. The at least one first outlet is formed at a lateral side surface of the inlet duct to be connected to the supply flow passage. The second inlet is formed at a lateral side surface of the outlet duct to be connected to the discharge flow passage. The second outlet is formed at an end of the outlet duct.

The present disclosure can achieve the effect of uniformly performing cooling of each battery module by distributing air when a plurality of battery modules is provided.

In addition, the present disclosure can achieve the effect of uniformly cooling the battery module by concentrating the air flow to the central part of the battery module by the guide plate provided in the intake/exhaust duct.

In addition, the present disclosure may achieve an effect of reducing the volume by improving the packaging property of the energy storage device through the intake/exhaust duct.

In addition, the present disclosure achieves an effect of avoiding unnecessary additional features when configuring an energy storage device by connecting a plurality of cell modules.

Effects obtainable from the present disclosure are not limited to the above-mentioned effects. Other effects not mentioned herein should be clearly understood from the following description by those having ordinary skill in the art to which the present disclosure pertains.

### BRIEF DESCRIPTION OF THE DRAWINGS

Since these drawings are for reference in explaining embodiments of the present disclosure, the technical idea of the present disclosure should not be construed as limited to the accompanying drawings.

FIG. 1 is a diagram illustrating an energy storage device having an intake and exhaust integrated duct according to an embodiment of the present disclosure.

FIG. 2 is an exploded view of an energy storage device equipped with an intake

and exhaust integrated duet according to an embodiment of the present disclosure.

FIG. 3 is a cross-sectional view taken along line A-A of FIG. 2.

FIG. 4 is a diagram illustrating an inlet duct of another embodiment in an energy storage device having an intake and exhaust integrated duct according to an embodiment of the present disclosure.

FIG. 5 is a view illustrating an inside of the inlet duct illustrated in FIG. 4.

FIGS. 6A and 6B are views illustrating two embodiments of a partition wall of an intake/exhaust duct in an energy storage device provided with an intake and exhaust integrated duct according to an embodiment of the present disclosure.

FIG. 7 is a view illustrating an extended structure of an inlet duct and an outlet duct in an energy storage device having an intake and exhaust integrated duct according to an embodiment of the present disclosure.

FIG. 8 is a view illustrating a guide plate formed on a partition wall of an intake/exhaust duct in the energy storage device provided with an intake and exhaust integrated duct according to an embodiment of the present disclosure.

FIG. 9 is a view illustrating a state in which an inlet duct is coupled to an intake/exhaust duct in an energy storage device having an intake and exhaust integrated duct according to an embodiment of the present disclosure.

FIG. 10 is a view illustrating a fastening unit formed in an intake duct or an exhaust duct in an energy storage system having an intake and exhaust integrated duct according to an embodiment of the present disclosure.

FIG. 11 is a view illustrating the overall flow of air in the energy storage device having an integrated intake/exhaust duct according to an embodiment of the present disclosure.

FIG. 12 is a diagram showing the overall flow of cooling air in a conventional energy storage device.

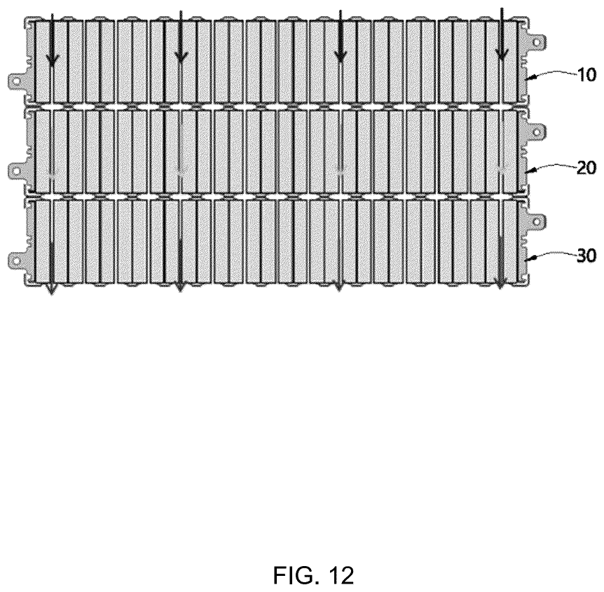

### DETAILED DESCRIPTION

Since the present disclosure may be modified in various ways and have various embodiments, specific embodiments are illustrated and described in the drawings. However, the present disclosure is not limited to the specific embodiments. It should be understood that the present disclosure is intended to cover all modifications, equivalents, and other embodiments, which may be included on the spirit and technical scope of the present disclosure as defined by the claims.

Terms including ordinals such as “first,” “second,” and the like, may be used to describe various elements, but the elements are not limited by the terms. The terms are used only for the purpose of distinguishing one component from another component.

The term “and/or” is used to include all cases of any terms agreement of a plurality of items to be included. For example, “A and/or B” includes all three cases such as “A,” “B.” and “A and B”.

In the present disclosure, when it is mentioned that a component is “connected” or “connected” to another component, the component may be directly connected or connected to the other component, but it should be understood that another component may exist therebetween. On the other hand, when it is stated that a component is “directly connected” or “directly connected” to another component, it is related to the absence of another component in the middle.

In the description of embodiments, it should be understood that a layer (film), region, pattem, or structure is formed “on” or “under” another layer (film), region, pattern, or structure, either directly or through intervening layers. The reference to “top/up” or “bottom/down” is based on the appearance shown in the drawings and is used to show the relative positional relationship between the components for convenience of explanation. The reference to “top/up” or “bottom/down” should not be understood as limiting the actual positions of the components. For example, unless “top B” is specifically mentioned or unless otherwise stated that due to the property of A or B, “B” is merely showing that B is shown above A in the drawings, and in the actual embodiments B may be positioned below A or B, and A may be disposed laterally in the actual embodiments or the like.

In addition, the thickness or size of each layer (film), region, pattern, or structure in the drawings may be modified for clarity and convenience of description, and thus does not entirely reflect the actual size.

The terminology used herein is for the purpose of describing particular embodiments only and is not intended to be limiting of the present disclosure. Singular expressions include plural expressions unless the context clearly indicates otherwise. In the present application, it should be understood that the term “include” or “have” indicates that a feature, a number, a step, an operation, a component, a part, or a combination thereof described in the specification is present. However, the term “include” or “have” does not exclude the possibility of existence or addition of one or more other features, numbers, steps, operations. components, parts, or combinations thereof in advance.

When a component, device, element, or the like of the present disclosure is described as having a purpose or performing an operation, function, or the like, the component, device, or element should be considered herein as being “configured to” meet that purpose or to perform that operation or function.

Unless otherwise defined, all terms used herein, including technical or scientific terms, have the same meaning as that is generally understood by those having ordinary skill in the art to which the present disclosure pertains. It should be further understood that terms, such as those defined in commonly used dictionaries, should be interpreted as having a meaning that is consistent with their meaning in the context of the relevant art and should not be interpreted in an idealized or overly formal sense unless expressly so defined herein.

Hereinafter, the embodiments should be described in detail with reference to the accompanying drawings, in which like feature elements are assigned to like reference numerals regardless of the drawing numbers and redundant descriptions thereof are omitted.

According to an embodiment of the present disclosure, the energy storage device having the intake and exhaust integrated duct includes a plurality of cell modules, an intake/exhaust duct 140, an inlet duct 230, an outlet duct 260, and a blower 340.

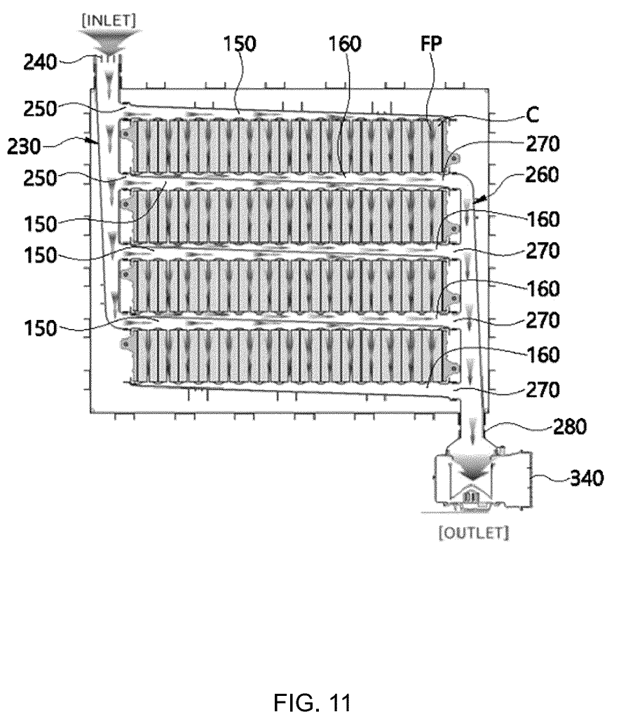

A plurality of cell modules means that a plurality of cells is disposed to be spaced apart from each other at a predetermined interval in one module, and at least two or more modules are disposed in parallel. Referring to FIG. 11, in one cell module, a plurality of cells C are spaced apart from each other at a predetermined interval. A cooling flow passage FP through which air flows may be formed between the cells C. In the present embodiment, four cell modules are provided, and although the embodiment of the present disclosure is described by defining the first cell module 100, the second cell module 110, the third cell module 120, and the fourth cell module 130 for easy explanation, four or more cell modules may be provided according to the embodiment.

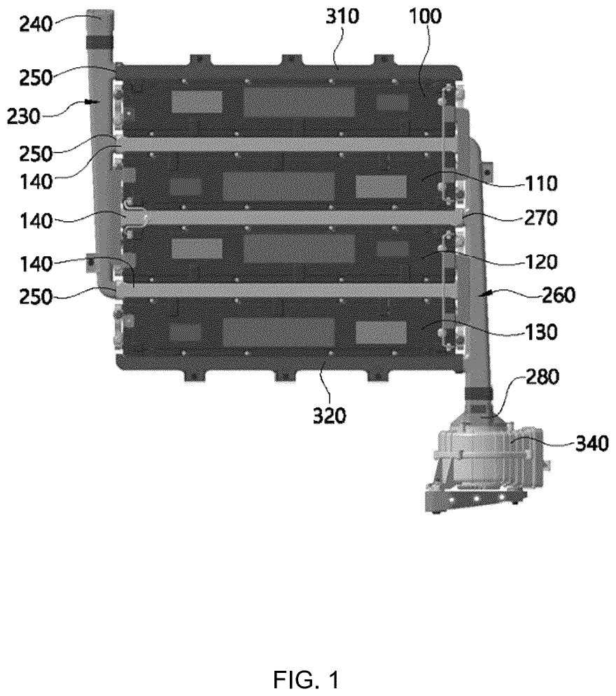

As shown in FIG. 1, multiple intake/exhaust ducts 140 may be used, and each intake/exhaust duct 140 may be installed between two cell modules. For example, FIG. 1 depicts four cell modules (i.e., the first cell module 100, the second cell module 110, the third cell module 120, and the fourth cell module 130) and three intake/exhaust ducts 140. A first intake/exhaust duct 140 is installed between the first cell module 100 and the second cell module 110, a second intake/exhaust duct 140 is installed between the second cell module 110 and the third cell module 120, and a third intake/exhaust duct 140 is installed between the third cell module 120 and the fourth cell module 130. Each intake/exhaust duct includes a supply flow passage 150 for supplying air to a respective cell module and a discharge flow passage 160 for discharging air discharged from the respective cell module. The supply flow passage 150 is formed at one side of the intake/exhaust duct 140 and the discharge flow passage 160 is formed at the other side of the intake/exhaust duct 140.

As mentioned above, one intake/exhaust duct 140 may be provided between two cell modules as shown in FIG. 1.

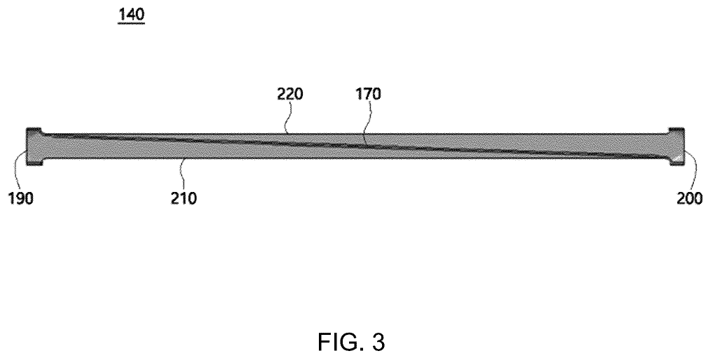

Referring to FIG. 3, each intake/exhaust duct 140 includes a first connection unit 190 to a fourth connection unit 220.

The first connection unit 190 is connected to a respective first outlet 250 at the one side of the intake/exhaust duct 140. The second connection unit 200 is connected to a respective second inlet 270 at the other side of the intake/exhaust duct 140. The first connection unit 190 and the second connection unit 200 are formed to have a wider cross-section than the intermediate portion formed between the first connection unit 190 and the second connection unit 200 of the intake/exhaust duct 140. This configuration is provided to improve fastening properties to prevent a cell module from moving in the longitudinal direction of the intake/exhaust duct 140 without a separate fixing device being needed by fastening the inlet duct 230 and the outlet duct 260 and simultaneously supporting the end of the cell module, as shown in FIG. 1.

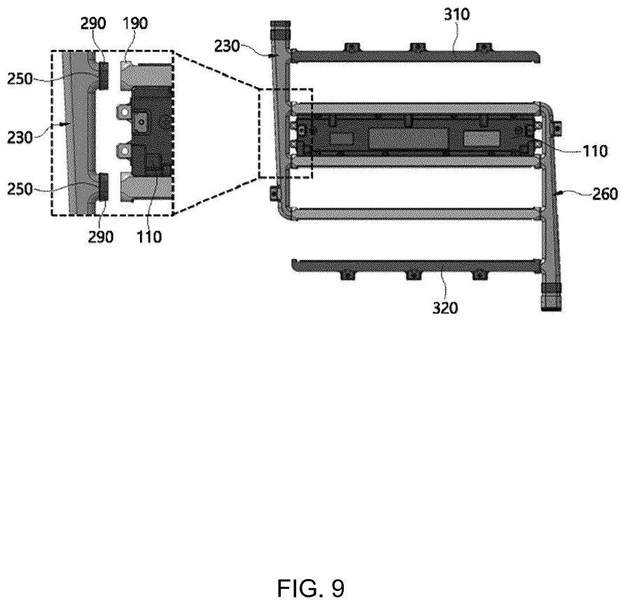

In more detail, referring to FIG. 9, the first connection unit 190 and the second connection unit 200 are formed to have a larger cross-sectional width, thereby restricting the cell module from moving in the longitudinal direction. The first connection unit 190 and the second connection unit 200 are connected to the inlet duct 230 and the outlet duct 260, respectively, thereby restricting the cell module from moving in the width direction.

The third connection unit 210 is formed to extend between the first connection unit 190 and the second connection unit 200. The third connection unit 210 has an opening at a side thereof which is connected to one side of a cell module to supply the air. In addition, the fourth connection unit 220 is formed to extend between the first connection unit 190 and the second connection unit 200. The fourth connection unit 200 has an opening at a side thereof which is connected to one side of another adjacent cell module to receive discharged air.

The inlet duct 230 has a first inlet 240 formed at one side thereof and at least one first outlet 250 formed at another side thereof to be connected to the supply flow passage 150.

Three first outlets 250 may be formed in the present embodiment, but may be increased or decreased according to the number of the cell modules. As shown in FIG. 1, the inlet duct 230 may be formed such that the cross-section thereof becomes narrower at a downstream portion thereof, i.e., narrower as going toward the direction of air flow. Accordingly, while the air is introduced into the first inlet 240 of the inlet duct 230, the air sequentially flows out through the three first outlets 250. The flow of the air introduced into the first outlet 250 at the end of the inlet duct 230 may be prevented from being reduced.

The outlet duct 260 has at least one second inlet 270 formed at one side thereof so as to be connected to the discharge flow passage 160. The outlet duct 260 also has a second outlet 280 formed at another side thereof. In the present embodiment, three second inlets 270 may be formed in the same manner as the first outlets 250, but may be increased or decreased according to the number of the cell modules.

As illustrated in FIG. 1, the outlet duct 260 may be formed such that the cross-section thereof becomes wider at a downstream portion thereof, i.e., narrower as going toward the direction of the air flow. Accordingly, air introduced into the three second inlets 270 formed in the outlet duct 260 may be rapidly discharged to the second outlet 280.

The inlet duct 230 and the outlet duct 260 are disposed on both sides of the cell modules, as illustrated in FIG. 1. In this case, since the inlet duct 230 and the outlet duct 260 are fixed to a housing (not illustrated), the intake/exhaust ducts 140 may be fixed without needing separate fixing members.

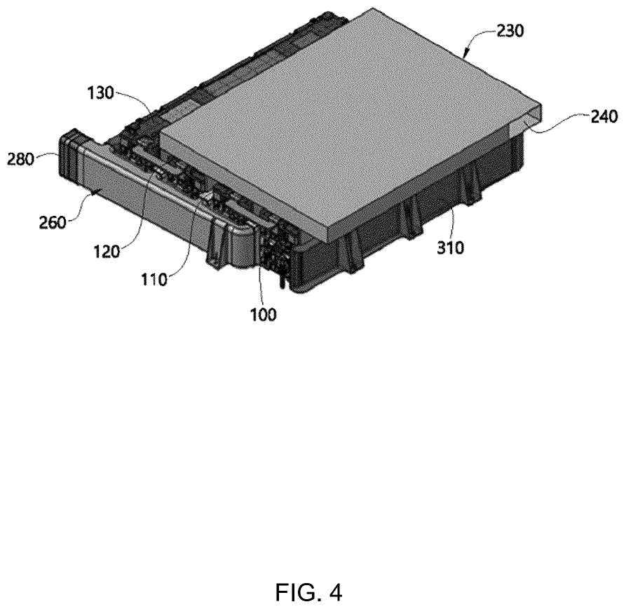

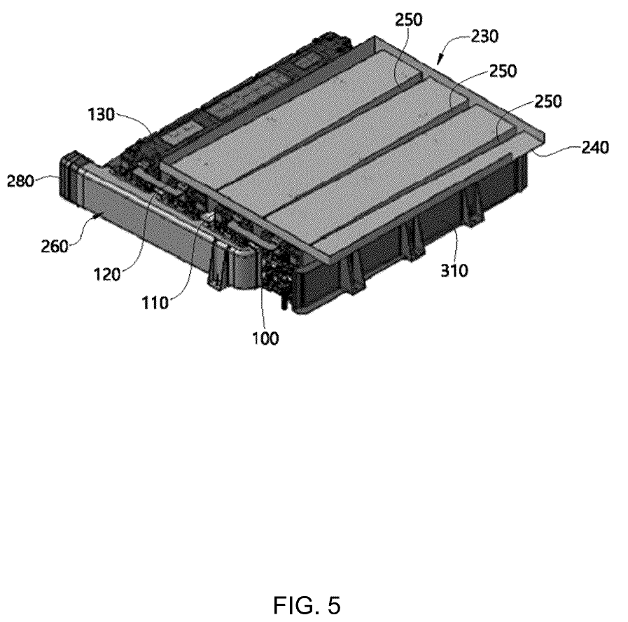

According to an embodiment, as illustrated in FIGS. 4 and 5, the inlet duct 230 may be located at one side surface or an upper part of the cell modules, and the outlet duct 260 may be located at another side surface of the cell modules or a lower part of the cell modules. Thus, the uniformity of air injected into the cell module may be improved.

As shown in FIG. 1, the blower 340 is installed in the second outlet 280 and is configured to generate a vacuum and suck air in through the inlet duct 230 to the cell modules (i.e., the first cell module 100 to the fourth cell module 130).

When the blower 340 is installed in the second outlet 280, the vacuum generated by the blower 340 causes the air in the outlet duct 260 to be discharged to the outside.

According to the present embodiment, the blower 340 may be installed in the first inlet 240, and in this case, the blower 340 may be configured to blow air into the first inlet 240. When the blower 340 is installed in the first inlet 240, it is possible to prevent the blower 340 from being exposed to hot air that was heated during the cooling process of the cell module.

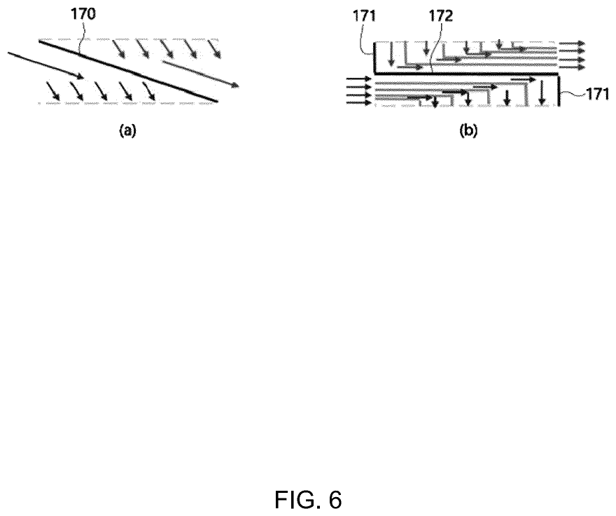

Referring to FIGS. 3 and 6A, each intake/exhaust duct 140 includes a partition wall 170 that separates the supply flow passage 150 and the discharge flow passage 160 from each other. The partition wall 170 is formed in a diagonal direction between the first connection unit 190 and the second connection unit 200. As shown in FIG. 6A, the partition wall 170 guides air introduced from the first connection unit 190 to be discharged to the third connection unit 210 (indicated by the arrows depicted below the partition wall 170). The partition wall 170 also guides air introduced from the fourth connection unit 220 to be discharged to the second connection unit 200 (indicated by the arrows depicted above the partition wall 170), thereby separating the supply flow passage 150 and the discharge flow passage 160 from each other in the intake/exhaust duct 140.

According to the present embodiment, as illustrated in FIG. 6B, the partition wall 170 may include a plurality of horizontal walls 172 and a plurality of vertical walls 171 perpendicularly connected to the plurality of horizontal walls 172 to allow air to flow in a perpendicular direction. In addition, as shown in FIG. 6B, when the partition wall 170 includes the vertical walls 171 and the horizontal walls 172, a plurality of partition walls may be provided to be spaced apart from each other at a predetermined interval, thereby achieving an effect capable of supplying air uniformly without biasing to the cell module.

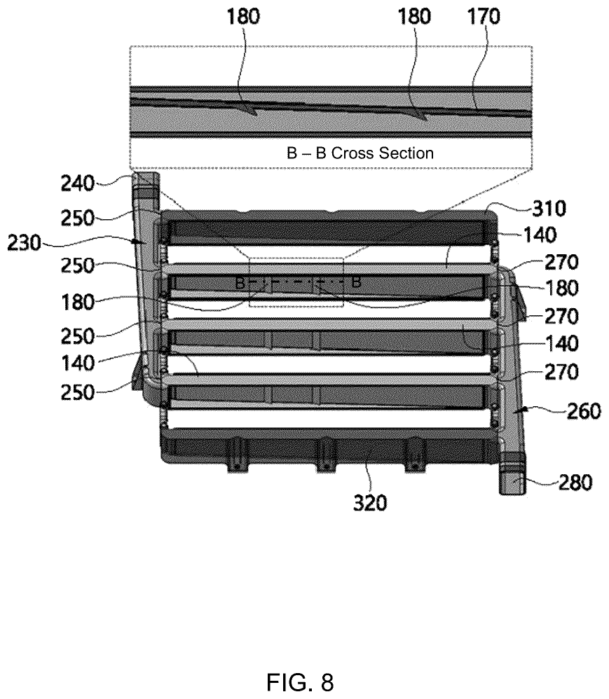

As shown in FIG. 8, the partition wall 170 may further include a guide plate 180 for guiding air to flow toward the center of the cell module. The guide plate 180 serves to guide air so that some of the air introduced from the first connection unit 190 moves to the center of the cell module and thus the plurality of cells are uniformly cooled overall.

Referring to FIG. 9, the first outlets 250 of the inlet duct 230 are inserted into the first connection units 190, respectively, and first sealing members 290 are installed on an outer surface of the respective first outlets 250. The second inlets 270 of the outlet duct 260 are inserted into the second connection units 200, respectively, and second sealing members (not shown) are installed on an outer surface of the respective second inlets 270. Although not shown in the drawings, the second sealing members have the same shape and mounting positions as the first sealing members. Thus, the second sealing members may refer to a coupling method as that of the first sealing members 290 shown in FIG. 9.

The first sealing members 290 and the second sealing members may improve airtightness among the inlet duct 230, the intake/exhaust ducts 140, and the outlet duct 260. It is desirable that the first sealing members 290 and the second sealing members are elastic materials. In particular, air heated by passing through the cell modules is discharged through the outlet duct 260. Accordingly, it is desirable that the second sealing members installed on the outer surface of the second inlets 270 of the heated outlet duct 260 is a heat-resistant rubber having excellent heat resistance performance.

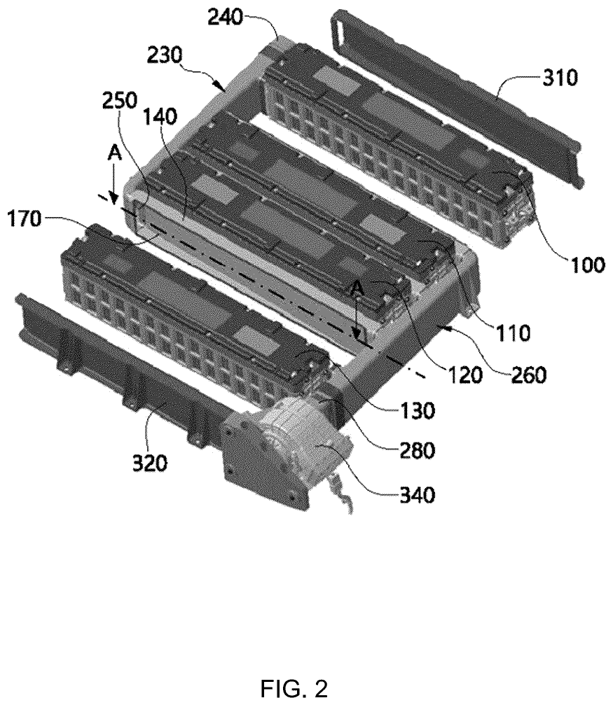

Referring to FIG. 2, the energy storage device having the intake and exhaust integrated duct may further include an intake duct 310 that is connected to a first outlet 250 of the first outlets 250 and having a supply flow passage 150 for supplying air to the first cell module 100. The energy storage device having the intake and exhaust integrated duct may further include an exhaust duct 320 that is connected to a second inlet 270 of the second inlets 270 and a discharge flow passage 160 for discharging air discharged from the fourth cell module 130.

The intake duct 310 and the exhaust duct 320 are configured such that the supply flow passage 150 and the discharge flow passage 160 of the intake/exhaust duct 140 are separately formed.

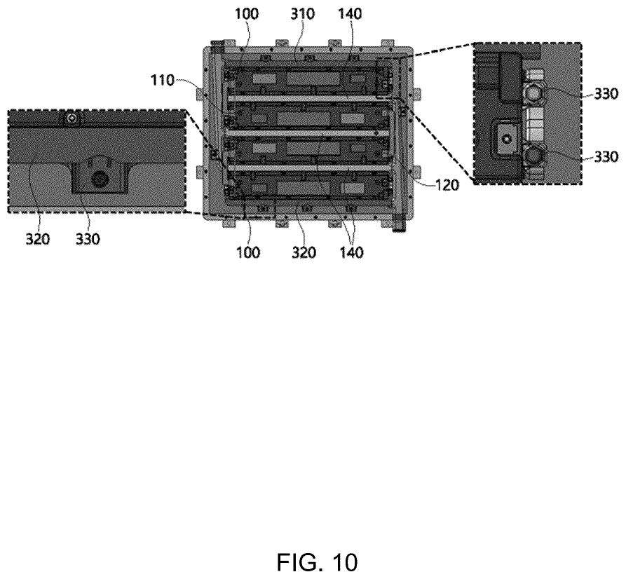

In the energy storage device having the intake and exhaust integrated duct, as illustrated in FIG. 10, a fastening unit 330 may be formed on outer surfaces of the inlet duct 230 and the outlet duct 260. The fastening unit 330 may be a bolt hole in the present embodiment, and the inlet duct 230 and the outlet duct 260 may be fixed to a lower case (not shown).

In addition, the fastening unit 330 may also be formed in the intake duct 310 and the exhaust duct 320, as described above, such that the intake duct 310 and the exhaust duct 320 may be fixed to the lower case.

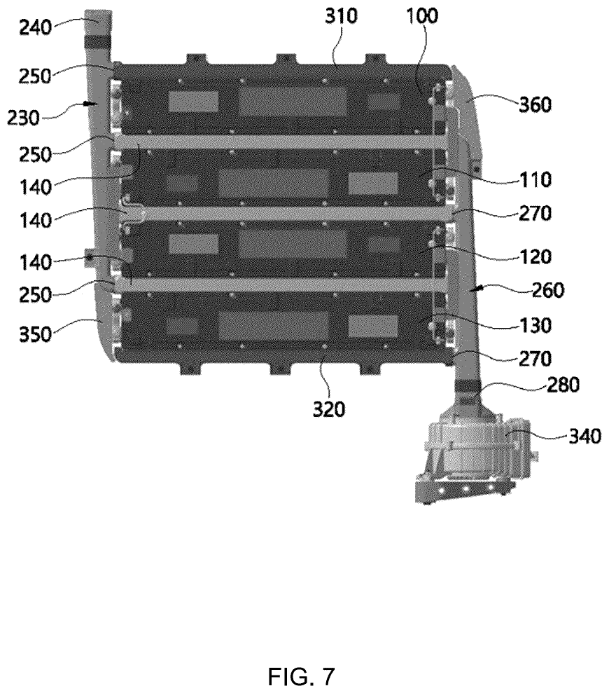

Referring to FIG. 7, the energy storage device having the intake and exhaust integrated duct according to the present embodiment further includes a first extension unit 350 formed at an opposite side of the first inlet of the inlet duct 230. Additionally, the energy storage device having the intake and exhaust integrated duct includes a second extension unit 360 formed at an opposite side of the second outlet 280 of the outlet duct 260 in order to strengthen the fixing force of the intake duct 310 and the exhaust duct 320.

As shown in FIG. 7, the first extension unit 350 and the second extension unit 360 support the ends of the intake duct 310 and the exhaust duct 320, which are described above. As a result, the first extension unit 350 and the second extension unit 360 achieve an effect of strengthening the fixing force of the intake duct 310 and the exhaust duct 320.

Although the above description has focused on the embodiments, it should be understood that this is merely illustrative and the present disclosure is not limited thereto. Various modifications and applications not illustrated above may be made without departing from the essential characteristics of the present disclosure. For example, each feature element shown as a sphere in the embodiment may be modified and implemented. Further, the differences related to the modifications and applications should be interpreted as being included in the scope of the present disclosure defined in the appended claims.

### DESCRIPTION OF SYMBOLS

100: First cell module
110: Second cell module
120: Third cell module
130: Fourth cell module
140: Intake/exhaust duct
150: Supply flow passage
160: Discharge flow passage
170: Partition wall
171: Vertical wall
172: Horizontal wall
180: Guide plate
190: First connection unit
200: Second connection unit
210: Third connection unit
220: Fourth connection unit
230: Inlet duct
240: First inlet
250: First outlet
260: Outlet duct
270: Second inlet
280: Second outlet
290: First sealing member
310: Intake duct
320: Exhaust duct
330: Coupling unit
340: Blower
350: First extension unit
360: Second extension unit

What is claimed is:

1. An energy storage device comprising:
a plurality of cell modules;
at least one intake/exhaust duct mounted among the plurality of cell modules,
wherein the at least one intake/exhaust duct comprises a first supply flow passage to supply air to one of the plurality of cell modules and a first discharge flow passage to discharge air discharged from one of the plurality of cell modules;
an inlet duct comprising a first inlet and at least one first outlet, each of which is connected to the first supply flow passage; and
an outlet duct comprising a second outlet and at least one second inlet, each of which is connected to the first discharge flow passage.

2. The energy storage device according to claim 1, wherein the at least one intake/exhaust duct comprises:
a first connection unit connecting to the at least one first outlet;
a second connection unit connecting to the at least one second inlet;
a third connection unit extending from the first connection unit toward the second connection unit and comprising an opening connecting to one side of a cell module of the plurality of cell modules; and
a fourth connection unit extending from the second connection unit toward the first connection unit and comprising an opening connecting to one side of another cell module of the plurality of cell modules.

3. The energy storage device according to claim 1, wherein the inlet duct and the outlet duct are disposed at both lateral sides of the plurality of cell modules.

4. The energy storage device according to claim 1, wherein the inlet duct is disposed above the plurality of cell modules and the outlet duct is disposed at a lateral side of the plurality of cell modules.

5. The energy storage device according to claim 1, wherein the inlet duct is disposed above the plurality of cell modules and the outlet duct is disposed below the plurality of cell modules.

6. The energy storage device according to claim 2, wherein the at least one intake/exhaust duct comprises a partition wall separating the first supply flow passage and the first discharge flow passage from each other, and wherein the partition wall extends in a diagonal direction between the first connection unit and the second connection unit.

7. The energy storage device according to claim 6, wherein the partition wall further comprises at least one guide plate configured to guide a flow of the air toward one of the plurality of cell modules.

8. The energy storage device according to claim 2, wherein the at least one first outlet is inserted into the first connection unit of the at least one intake/exhaust duct and a first sealing member is mounted on an outer surface of the at least one first outlet.

9. The energy storage device according to claim 2, wherein the at least one second inlet is inserted into the second connection unit of the at least one intake/exhaust duct and a second sealing member is mounted on an outer surface of the at least one second inlet.

10. The energy storage device according to claim 1, further comprising:
an intake duct connected to the at least one first outlet and comprising a second supply flow passage for supplying air to one of the plurality of cell modules; and
an exhaust duct connected to the at least one second inlet and comprising a second discharge flow passage for discharging air discharged from one of the plurality of cell modules.

11. The energy storage device according to claim 10, wherein the inlet duct further comprises a first extension unit connected to the exhaust duct, and wherein the outlet duct further comprises a second extension unit connected to the intake duct.

12. The energy storage device according to claim 1, wherein the inlet duct and the outlet duct further comprise fastening units.

13. The energy storage device according to claim 1, further comprising a blower located at the first inlet or the second outlet and configured to discharge air introduced from the first inlet to the second outlet.

14. The energy storage device according to claim 2, wherein the at least one intake/exhaust duct comprises a partition wall configured to separate the first supply flow passage and the first discharge flow passage from each other, and wherein the partition wall comprises a plurality of horizontal walls extending in a longitudinal direction and a plurality of vertical walls extending in a perpendicular direction from ends of the plurality of horizontal walls.

15. The energy storage device according to claim 1, wherein the inlet duct is formed to have a cross-section that becomes narrower at a downstream portion.

16. The energy storage device according to claim 1, wherein the outlet duct is formed to have a cross-section which becomes wider at a downstream portion.

17. The energy storage device according to claim 2, wherein the first connection unit and the second connection unit have cross-sections wider than that of an intermediate portion formed between the first connection unit and the second connection unit.

18. The energy storage device according to claim 1, wherein the first inlet is formed at an end of the inlet duct, wherein the at least one first outlet is formed at a lateral side surface of the inlet duct to be connected to the first supply flow passage, wherein the second inlet is formed at a lateral side surface of the outlet duct to be connected to the first discharge flow passage, and wherein the second outlet is formed at an end of the outlet duct.
